(19) United States
(12) Patent Application Publication
(10) Pub. No.: US 2023/0364843 A1
(43) Pub. Date: Nov. 16, 2023

(54) RESIN FIBER FORMATION NOZZLE, RESIN FIBER MANUFACTURING APPARATUS, AND RESIN FIBER MANUFACTURING METHOD

(71) Applicant: NITTO DENKO CORPORATION, Ibaraki-shi, Osaka (JP)

(72) Inventors: Hajime Michihira, Osaka (JP); Teppei Okumura, Osaka (JP); Takashi Kumano, Osaka (JP); Yuto Nagaya, Osaka (JP)

(73) Assignee: NITTO DENKO CORPORATION, Ibaraki-shi, Osaka (JP)

(21) Appl. No.: 18/029,146

(22) PCT Filed: Sep. 13, 2021
(86) PCT No.: PCT/JP2021/033605

§ 371 Date: Mar. 29, 2023

(30) Foreign Application Priority Data
Sep. 30, 2020 (JP) 2020-164971

(51) Int. Cl. B29C 48/05; B29C 48/30; B29C 48/21; B29C 48/885; B29C 48/793

(52) U.S. Cl. CPC B29C 48/05; B29C 48/304; B29C 48/21; B29C 48/885; B29C 48/793; B29L 2011/0075

(57) ABSTRACT

A resin fiber formation nozzle 20 of the present invention is a nozzle configured to discharge a molten resin material into a fiber shape. The nozzle 20 includes: the internal flow path 21; an inlet 22 that allows the resin material to flow into the internal flow path 21; and an outlet 23 that allows the resin material to be discharged from the internal flow path 21 to an outside of the nozzle 20. The internal flow path 21 is shaped such that a diameter of the internal flow path 21 decreases continuously, in a section from a position A 5 mm upstream in the internal flow path 21 from the outlet 23 to a position B of the outlet 23, from the position A toward the position B.

### TECHNICAL FIELD

The present invention relates to a resin fiber formation nozzle, a resin fiber manufacturing apparatus including the resin fiber formation nozzle, and a resin fiber manufacturing method.

### BACKGROUND ART

Melt spinning is known as one of the methods for manufacturing a resin fiber such as a plastic optical fiber (hereinafter referred to as “POF”). According to melt spinning, for example, a molten resin material is delivered to a nozzle to be discharged into a fiber shape through an outlet of the nozzle. The resin material discharged into a fiber shape is solidified by cooling to produce a resin fiber.

It has been considered desirable for stable production of a fiber having an intended outer diameter that a nozzle used as above in melt spinning includes an internal flow path extending from a vicinity of an outlet to the outlet and having a constant diameter, in other words, has an internal flow path linearly extending such that an inner wall surface of the internal flow path extending from the vicinity of the outlet to the outlet is substantially perpendicular to an outlet face of the nozzle. For example, as disclosed in Patent Literature 1, an outlet of a nozzle used to manufacture a POF by melt extrusion has a land extending parallel to a discharging direction in order to stabilize the fiber shape. The land in the outlet portion of the nozzle is part of the nozzle. When passing through the land in an apparatus, a resin material is in a molten state and the pressure inside the apparatus is equal to or higher than the atmospheric pressure. Consequently, the molten resin material is discharged out of the nozzle in a state where the molten resin material is in contact with an inner wall of the land. Therefore, the shape of the fiber of the resin material is determined at the time of emission of the resin material from the tip of the land to the outside. That is, when the land is in an outlet portion of the nozzle, the tip of the land serves substantially as an outlet of the nozzle. Incidentally, lands are sometimes called guides.

Additionally, for example, nozzles disclosed in Patent Literatures 2 and 3 and used to manufacture a POF by melt extrusion are configured to include a flow path having a cross-section corresponding to that of an intended POF, the flow path extending linearly to an outlet.

### CITATION LIST

### Patent Literature

Patent Literature 1: JP 2000-356716 A

Patent Literature 2: JP 2006-163007 A

Patent Literature 3: JP 2011-253005 A

### SUMMARY OF INVENTION

### Technical Problem

Even by using, to manufacture a resin fiber by melt spinning, conventional nozzles considered capable of stably achieving an intended outer diameter, it is difficult to sufficiently reduce variations of the outer diameter of a manufactured resin fiber.

Therefore, the present invention aims to provide a resin fiber formation nozzle capable of, when used to manufacture a resin fiber by melt spinning, reducing variations of the outer diameter of the resulting resin fiber more than conventional nozzles. Moreover, the present invention also aims to provide, using such a resin fiber formation nozzle, a resin fiber manufacturing apparatus and a resin fiber manufacturing method capable of reducing variations of the outer diameter of a resin fiber manufactured thereby more than conventional apparatuses and methods.

### Solution to Problem

As a result of intensive studies on nozzles used in manufacturing of resin fibers, the present inventors have found that the shape of a nozzle conventionally considered capable of stably achieving an intended outer diameter can be improved further. Specifically, the present inventors have found that the shape of a portion which is part of an internal flow path of such a nozzle and which a resin material passes through just before discharged can be improved further. In the technical field of resin fibers, it has been considered desirable that an inner wall surface of an internal flow path extending from a vicinity of an outlet of a nozzle used in melt spinning to the outlet be formed to be perpendicular to an outlet face of the nozzle. However, as a result of intensive studies, the present inventors have newly found that for further reduction of variations of the outer diameter of the resulting resin fiber, it is important to reduce, to the outlet, the diameter of the internal flow path which a resin material passes through just before discharged.

On the basis of the above findings, the present inventors have reached the following nozzles of the present invention.

A resin fiber formation nozzle according to a first aspect of the present invention is a nozzle configured to discharge a molten resin material into a fiber shape, and includes:
an internal flow path;
an inlet that allows the resin material to flow into the internal flow path; and
an outlet that allows the resin material to be discharged from the internal flow path to an outside of the nozzle, and
the internal flow path is shaped such that a diameter of the internal flow path decreases continuously, in a section from a position A 5 mm upstream in the internal flow path from the outlet to a position B of the outlet, from the position A toward the position B.

An apparatus for manufacturing a resin fiber according to a second aspect of the present invention includes:
an extrusion apparatus including: a holding portion that holds a resin material being a raw material of the resin fiber; and an extrusion portion that extrudes the resin material in a molten state from the holding portion; and
a nozzle that discharges, into a fiber shape, the resin material in a molten state extruded from the extrusion apparatus, and
the nozzle is the resin fiber formation nozzle according to the first aspect.

A resin fiber manufacturing method according to a third aspect of the present invention includes allowing a molten resin material to flow into the internal flow path of the above resin fiber formation nozzle according to the first aspect through the inlet and to be discharged into a fiber shape through the outlet.

A resin fiber manufacturing method according to a fourth aspect of the present invention includes:
extruding, from the extrusion apparatus of the resin fiber manufacturing apparatus according to the second aspect, a resin material being a raw material of the resin fiber; and
allowing the resin material extruded from the extrusion apparatus to flow into the internal flow path through the inlet of the nozzle of the manufacturing apparatus and to be discharged a fiber shape through the outlet.

### Advantageous Effects of Invention

Using the resin fiber formation nozzle according to the first aspect of the present invention to manufacture a resin fiber by melt spinning, it is possible to reduce variations of the outer diameter of the resulting resin fiber more than using conventional nozzles. Moreover, by the resin fiber manufacturing apparatus according to the second aspect of the present invention and the resin fiber manufacturing methods according to the third and fourth aspects of the present invention, it is possible to reduce variations of the outer diameter of a resin fiber manufactured thereby more than by conventional apparatuses and methods.

### BRIEF DESCRIPTION OF DRAWINGS

FIG. 1 is a schematic cross-sectional view showing an example of a resin fiber manufacturing apparatus of an embodiment of the present invention.

FIG. 2 is a schematic cross-sectional view showing an example of a resin fiber formation nozzle according to an embodiment of the present invention.

FIG. 3 is a schematic cross-sectional view showing another example of the resin fiber formation nozzle according to the embodiment of the present invention.

FIG. 4 is a schematic cross-sectional view showing a POF manufacturing apparatus, which is another example of the resin fiber manufacturing apparatus of the embodiment of the present invention.

FIG. 5 shows a graph showing the result for outer diameter measurement for a resin fiber manufactured using a resin fiber formation nozzle according to Example 1.

FIG. 6 is a schematic cross-sectional view showing a resin fiber formation nozzle used in Comparative Examples 1 and 2.

FIG. 7 shows a graph showing the result for outer diameter measurement for a resin fiber manufactured using a resin fiber formation nozzle according to Comparative Example 1.

FIG. 8 shows a graph showing the result for outer diameter measurement for a resin fiber manufactured using a resin fiber formation nozzle according to Comparative Example 2.

### DESCRIPTION OF EMBODIMENTS

Embodiments of a resin fiber formation nozzle, a resin fiber manufacturing apparatus, and a resin fiber manufacturing method of the present invention will be described.

An apparatus for manufacturing a resin fiber according to the present embodiment includes:
an extrusion apparatus including: a holding portion that holds a resin material being a raw material of the resin fiber; and an extrusion portion that extrudes the resin material in a molten state from the holding portion, and
a nozzle that discharges, into a fiber shape, the resin material in a molten state extruded from the extrusion apparatus.

The above nozzle provided in the resin fiber manufacturing apparatus of the present embodiment is a resin fiber formation nozzle of the present embodiment. The resin fiber formation nozzle of the present embodiment includes: an internal flow path; an inlet that allows a resin material to flow into the internal flow path; and an outlet that allows the resin material to be discharged from the internal flow path to an outside of the nozzle. The internal flow path is shaped such that a diameter of the internal flow path decreases continuously, in a section from a position A 5 mm upstream in the internal flow path from the outlet to a position B of the outlet, from the position A toward the position B. By using the nozzle having the above shape, variations of the outer diameter of a resin fiber manufactured by using the nozzle can be reduced. For example, by using the nozzle of the present embodiment, a ratio 3σ/AVE of a three-fold value (3τ) of a standard deviation of outer diameters of a resin fiber manufactured by using the nozzle to an average (AVE) of the outer diameters of the resin fiber can be reduced to, for example, 3% or less.

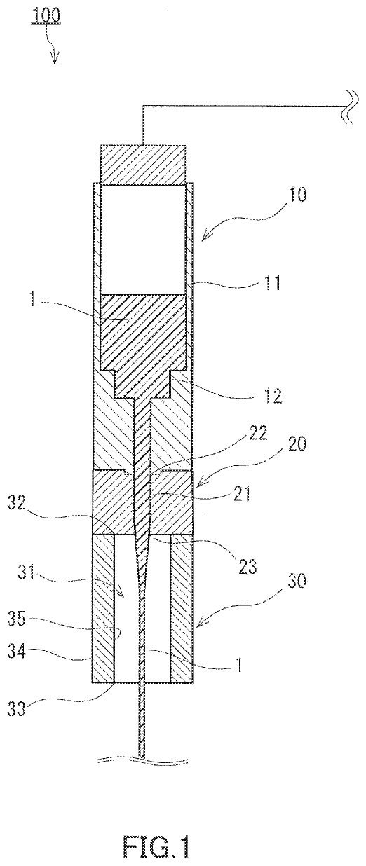

FIG. 1 is a schematic cross-sectional view showing an example of the resin fiber manufacturing apparatus of the present embodiment.

A resin fiber manufacturing apparatus 100 shown in FIG. 1 includes an extrusion apparatus 10 and a nozzle 20. The extrusion apparatus 10 includes: a holding portion 11 that holds a resin material 1 being a raw material of a resin fiber; and an extrusion portion 12 that extrudes the resin material 1 in a molten state from the holding portion 11. The resin material 1 extruded from the extrusion apparatus 10 flows into an internal flow path 21 through an inlet 22 of the nozzle 20 and is discharged to an outside of the nozzle through an outlet 23.

The resin fiber formation nozzle of the present embodiment is used as the nozzle 20.

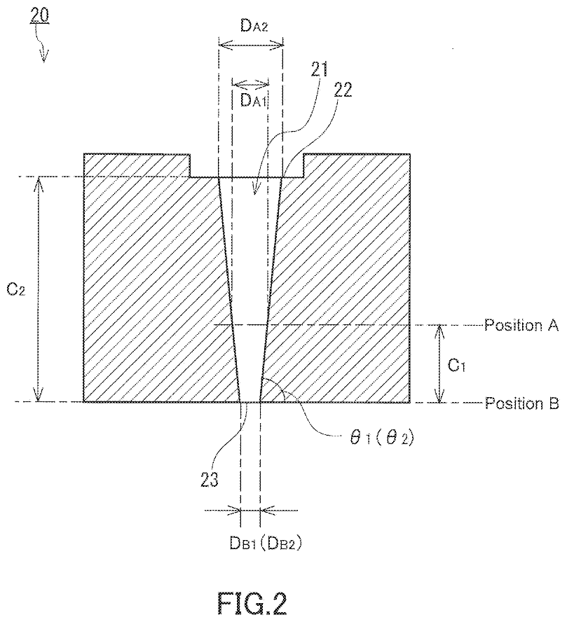

FIG. 2 shows a configuration of an example of the resin fiber formation nozzle of the present embodiment used as the nozzle 20. The nozzle 20 includes: the internal flow path 21; the inlet 22 that allows the resin material 1 to flow into the internal flow path 21; and the outlet 23 that allows the resin material 1 to be discharged into a fiber shape from the internal flow path 21 to the outside of the nozzle 20. The internal flow path 21 is shaped such that a diameter of the internal flow path 21 decreases continuously, in a section from a position A 5 mm upstream in the internal flow path 21 from the outlet 23 to a position B of the outlet 23, from the position A toward the position B. It is preferable that the internal flow path 21 be shaped such that the internal flow path 21 as a whole has a continuously decreasing diameter. That is, it is preferable that the internal flow path 21 be shaped such that the diameter of the internal flow path 21 decreases continuously from the inlet 22 toward the outlet 23.

The outlet 23 of the nozzle 20 is an exit portion through which a fluid comes out from the internal flow path 21 of the nozzle 20 to the outside of the nozzle. Therefore, for the nozzle 20 configured to have a land in an outlet portion, the outlet 23 of the nozzle 20 is an opening portion at the tip of the land.

The internal flow path 21 of the nozzle 20 preferably has, as shown in FIG. 2, a tapered shape narrowing from the position A toward the position B. In this case, the internal flow path 21 more preferably satisfies the following range (I) in the section from the position A to the position B:

4≤tan θ₁≤100 . . . (I).

The value tan θ₁ is even more preferably 8 or more, and particularly preferably 10 or more. The value tan θ₁ is even more preferably 90 or less, and particularly preferably 80 or less.

In the above range (I), θ₁ represents a taper angle, and tan θ₁ is determined by the following equation (II).

tan θ₁=(a distance C₁ from the position A to the position B)/0.5(a diameter D_{A1} of the internal flow path 21 at the position A−a diameter D_{B1} of the internal flow path 21 at the position B) . . . (II)

It should be noted that the diameter D_{B1} of the internal flow path 21 at the position B corresponds to the diameter of the outlet 23. The distance C₁ from the position A to the position B is 5 mm.

The internal flow path 21 is preferably has a tapered shape throughout the entire internal flow path 21. That is, the internal flow path 2 preferably has a tapered shape, as shown in FIG. 2, from the inlet 22 toward the outlet 23. In this case, the internal flow path 21 more preferably satisfies the following range (III) in the section from the inlet 22 to the outlet 23:

4≤tan θ₂≤100 . . . (III).

The value tan θ₁ is even more preferably 8 or more, and particularly preferably 10 or more. The value tan θ₁ is even more preferably 90 or less, and particularly preferably 80 or less.

In the above range (III), θ₂ represents a taper angle, and tan θ₂ is determined by the following equation (IV).

tan θ₂=(a distance C₂ from the inlet 22 to the outlet 23)/0.5(a diameter D_{A2} of the inlet 22−a diameter D_{B2} of the outlet 23) . . . (IV)

The diameter of the outlet 23 of the nozzle 20 needs to be selected according to the outer diameter of an intended resin fiber, and is not limited to a particular one. For example, for manufacture of a POF as a resin fiber, the outlet 23 of the nozzle 20 may have a diameter of, for example, 0.3 to 30 mm. Even in the case where a resin fiber having such a small diameter is manufactured, it is possible to reduce variations of the outer diameter of the resin fiber (for example, reduce the ratio 3σ/AVE to 3% or less) by using the nozzle 20 of the present embodiment.

The extrusion apparatus 1 of the manufacturing apparatus 100 may further include a heating portion (not illustrated) that heats and melts the resin material 1 in the holding portion 11. For example, a rod-shaped resin material may be supplied as the resin material 1 to the holding portion 11 and heated in the holding portion 11 to be molten, and the molten resin material 1 may be extruded from the holding portion 11 by the extrusion portion 12.

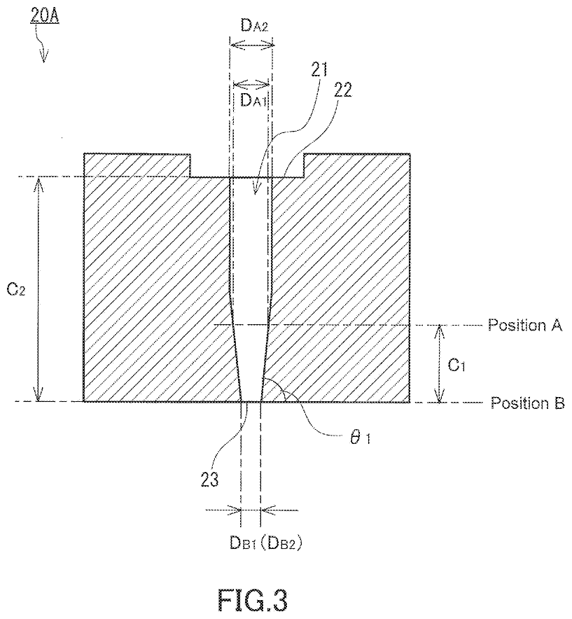

The shape of the internal flow path in the resin formation nozzle of the present embodiment is not limited to that of the nozzle 20 shown in FIG. 2. In the resin formation nozzle of the present embodiment, the internal flow path 21 is required to be shaped such that the diameter of the internal flow path 21 decreases continuously from the position A toward the position B in the section from the position A to the position B. The shape of the internal flow path 21 in a section from the inlet 22 to the position A is not limited to a particular one. For example, as in a resin fiber formation nozzle 20A, which is another example, shown in FIG. 3, the diameter of the internal flow path 21 does not need to decrease continuously from the inlet 22 toward the position A in the section from the inlet 22 to the position A. For example, the diameter of the internal flow path 21 may be constant from the inlet 22 to the position A.

The resin fiber manufacturing apparatus 100 preferably further includes a cooling pipe 30. The cooling pipe 30 includes an internal space 31 that allows the resin material 1 discharged into a fiber shape through the outlet 23 of the nozzle 20 to pass through the internal space 31. The cooling pipe 30 can reduce disturbance of the fiber-shaped resin material 1 passing through the internal space 31 attributable to external air (air existing outside). Consequently, the fiber-shaped resin material 1 discharged from the nozzle 20 can be cooled without being affected by external air. This makes it possible to further reduce variations of the outer diameter of a resin fiber to be manufactured.

As shown in FIG. 1, the cooling pipe 30 is provided such that, for example, the cooling pipe 30 is connected to the nozzle 20. The cooling pipe 30 includes a first opening portion 32 on the upper side and a second opening portion 33 on the lower side, the portions each communicating with the internal space 31. The cooling pipe 30 is, for example, connected to the nozzle 20 and extends downward from the nozzle 20. The first opening portion 32 of the cooling pipe 30 surrounds, for example, the outlet 23 of the nozzle 20. The first opening portion 32, the internal space 31, and the second opening portion 33 of the cooling pipe 30 are designed so that the resin material 1 discharged through the outlet 23 of the nozzle 20 will not touch an inner wall 35 of the cooling pipe 30. The diameters of the first opening portion 32, the internal space 31, and the second opening portion 33 of the cooling pipe 30 are preferably larger than that of the diameter of the outlet 23 of the nozzle 20 by 15 mm or more.

The cooling pipe 30 is required to be in a tubular shape that can have the internal space 31 separated from external air, and the structure of the cooling pipe 30 is not limited to a particular one. The cooling pipe 30 has, for example, a cylindrical tubular shape.

The length of the cooling pipe 30 is preferably 100 mm or more, more preferably 200 mm or more, or more preferably 300 mm or more.

A holding space (not illustrated) that can hold a refrigerant may be further provided between an outer wall 34 of the cooling pipe 30 and the inner wall 35 facing the internal space 31 of the cooling pipe 30. In this case, the cooling pipe 30 may further include a mechanism (such as a refrigerant supply path and a refrigerant exhaust path) for supplying the refrigerant to the holding space. For example, a liquid such as water can be used as the refrigerant.

The cooling pipe 30 may further include a mechanism (not illustrated) for supplying a cooling fluid to the internal space 31. The cooling fluid is, for example, a gas. The gaseous cooling fluid is, for example, an inert gas such as air or helium, and is preferably air. The cooling pipe 30 may further include a tubular filter (not illustrated) for regulating the cooling fluid. This tubular filter is provided in the internal space 31. The filter has, for example, a cylindrical tubular shape. The cooling fluid is introduced, for example, to a space between the inner wall 35 of the cooling pipe 30 and the filter. The filter is, for example, formed of a material, such as a non-woven fabric, a woven fabric, or a mesh, permeable to the cooling fluid. The filter extends, for example, in the same direction as the cooling pipe 30. The length of the filter may be the same as or different from that of the cooling pipe 30. In this case, the fiber-shaped resin material 1 passes through an internal space surrounded by the filter. That is, the internal space surrounded by the filter can be regarded as a portion of the internal space 31 of the cooling pipe 30. The cooling pipe 30 may have, instead of the filter, a tubular wall portion impermeable to the cooling fluid.

The resin fiber manufacturing apparatus 100 shown in FIG. 1 is an example of the resin fiber manufacturing apparatus of the present embodiment. The resin fiber manufacturing apparatus 100 is an apparatus for manufacturing a resin fiber using one resin material, but the resin fiber manufacturing apparatus of the present embodiment is not limited to this apparatus. For example, the resin fiber manufacturing apparatus of the present embodiment may be configured to use a plurality of resin materials and allow a body formed by layering these resin materials concentrically, for example, by multilayer melt extrusion to flow into the nozzle 20 to be discharged into a fiber shape from the nozzle 20. As just described, by means of the resin fiber manufacturing apparatus of the present embodiment, it is possible to manufacture a resin fiber by using a plurality of resin materials and allowing these resin materials concentrically layered by multilayer melt extrusion to be discharged into a fiber shape from the nozzle 20.

A resin fiber manufactured by the present embodiment may be, for example, a POF. The POF includes, for example, a core and a clad disposed on an outer circumference of the core. That is, the resin fiber manufacturing apparatus of the present embodiment may be a POF manufacturing apparatus.

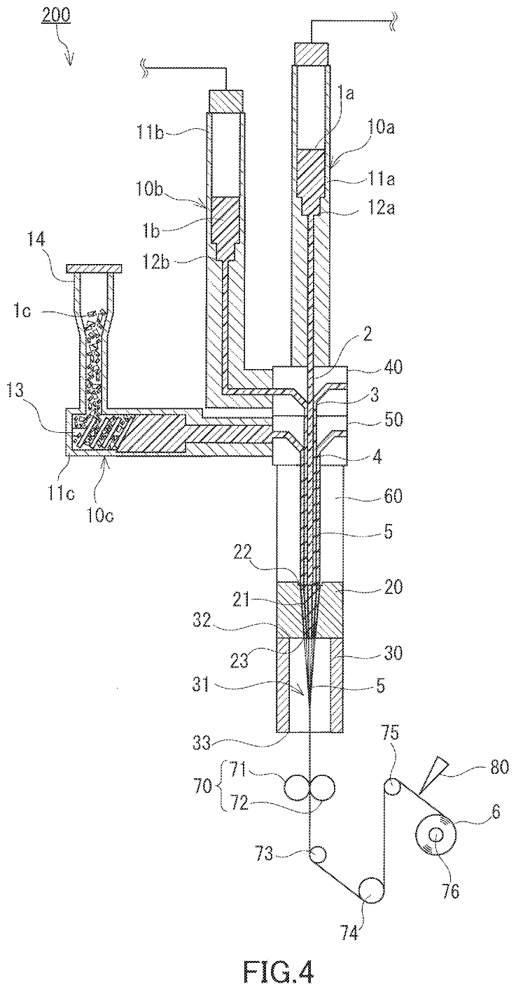

FIG. 4 is a schematic cross-sectional view showing a POF manufacturing apparatus 200, which is another example of the resin fiber manufacturing apparatus of the present embodiment.

The apparatus 200 shown in FIG. 4 includes a first extrusion apparatus 10a for core formation, a second extrusion apparatus 10b for clad formation, and a third extrusion apparatus 10c for overclad formation. The apparatus 200 further includes a first chamber 40 and a second chamber 50. The first chamber 40 and the second chamber 50 are vertically arranged in this order from top to bottom. The POF manufacturing apparatus 200 described here is an exemplary apparatus which includes the first extrusion apparatus 10a for core formation, the second extrusion apparatus 10b for clad formation, and the third extrusion apparatus 10c for overclad formation and in which three resin materials are used. However, the POF manufacturing apparatus of the present embodiment may be an apparatus which includes the first extrusion apparatus 10a for core formation and the second extrusion apparatus 10b for clad formation and in which two resin materials are used.

The first extrusion apparatus 10a includes: a first holding portion 11a that holds a first resin material 1a having composition suitable for the core of a POF; and a first extrusion portion 12a that extrudes the first resin material 1a held in the first holding portion 11a from the first holding portion 11a. The first holding portion 11a and the first extrusion portion 12a respectively have the same functions as those of the holding portion 11 and the extrusion portion 12 of the apparatus 100 shown in FIG. 1. The first extrusion apparatus 10a may be further provided with a heating portion (not illustrated) such as a heater so that the first resin material 1a can be molten in the first holding portion 11a and, furthermore, the molten first resin material 1a can be in a molten state until shaped. In this case, for example, the resin material (preform) 1a in a rod shape is put in the first holding portion 11a through an upper opening portion of the first holding portion 11a and is then heated in the first holding portion 11a to be molten.

In the first extrusion apparatus 10a, the first resin material 1a is extruded from the first holding portion 11a through the first extrusion portion 12a to the outside, for example, by gas extrusion to form a core 2. The first resin material 1a extruded through the first extrusion portion 12a to form the core 12 then moves vertically downward and is supplied to the first chamber 40 and the second chamber 50 in this order.

The second extrusion apparatus 10b includes, for example: a second holding portion 11b that holds a second resin material 1b having composition suitable for the clad of a POF; and a second extrusion portion 12b that extrudes the second resin material 1b held in the second holding portion 11b from the second holding portion 11b. The second extrusion apparatus 10b extrudes the molten second resin material 1b to cover the outer circumference of the core 2 formed of the first resin material 1a extruded from the first extrusion apparatus 10a. Specifically, the second resin material 1b discharged from the second extrusion apparatus 10b is supplied to the first chamber 40. A clad 3 covering the outer circumference of the core 2 can be formed in the first chamber 40 by covering the core 2 formed of the first resin material 1a with the second resin material 1b. A layered body formed of the core 2 and the clad 3 covering the outer circumference of the core 2 moves from the first chamber 40 to the second chamber 50.

The third extrusion apparatus 10c includes, for example, a third holding portion 11c that holds a third resin material 1c having composition suitable for the overclad (coating layer) of a POF, a screw 13 disposed in the third holding portion 11c, and a hopper 14 connected to the third holding portion 11c. In the third extrusion apparatus 10c, for example, the third resin material 1c in a pellet shape is supplied to the third holding portion 11c through the hopper 14. The third resin material 1c supplied to the third holding portion 11c becomes soft and flowable, for example, by being kneaded by the screw 13 under heating. The softened third resin material 1c is extruded from the third holding portion 11c by the screw 13.

The third resin material 1c extruded from the third extrusion apparatus 10c is supplied to the second chamber 50. An overclad 4 covering the outer circumference of the clad 3 can be formed in the second chamber 50 by covering a surface of the layered body formed of the core 2 and the clad 3 with the third resin material 1c.

A layered body 5 in which the core 2, the clad 3, and the overclad 4 are concentrically layered moves from the second chamber 50 to a dispersing tube 60 disposed vertically under the second chamber 50. For example, a heater (not illustrated) for heating the layered body 5 may be disposed in the dispersing tube 60. In the dispersing tube 60, for example, the temperature and the viscosity of the layered body 5 passing inside are adjusted as appropriate. The dispersing tube 60 can disperse, in the layered body 5, a dopant, such as a refractive index modifier, included in the layered body 5 passing inside the dispersing tube 60.

The dispersing tube 60 communicates with the internal flow path 21 of the nozzle 20. That is, a lower opening portion of the dispersing tube 60 communicates with the inlet 22 of the nozzle 20, and the layered body 5 having passed through the dispersing tube 60 flows into the internal flow path 21 through the inlet 22 of the nozzle 20. The diameter of the layered body 5 is reduced while the layered body 5 is passing through the internal flow path 21. The layered body 5 is then discharged into a fiber shape through the outlet 23. The shape of the internal flow path 21 of the nozzle 20 is as described above. By using the nozzle 20 of the present embodiment, variations of the outer diameter of the fiber-shaped layered body 5 discharged through the outlet 23 can be reduced. As a result, a POF having an intended outer diameter can be stably manufactured.

The layered body 5 discharged into a fiber shape through the outlet 23 of the nozzle 20 flows, for example, into the internal space 31 through the first opening portion 32 of the cooling pipe 30. The layered body 5 is cooled while passing inside the internal space 31. The layered body 5 is then emitted from the cooling pipe 30 through the second opening portion 33. The layered body 5 emitted from the cooling pipe 30, for example, passes between two rolls 71 and 72 of a nip roll 70 and then along guide rolls 73 to 75, and is wound as a POF 6 around a winding roll 76. A displacement meter 80 for measuring the outer diameter of the POF 6 may further be provided near the winding roll 76, such as between the guide roll 75 and the winding roll 76.

The first resin material 1a preferably has composition suitable for the core 2 of the POF 6. The first resin material 1a includes, for example, a fluorine-containing polymer (polymer (P)). From the viewpoint of reducing light absorption attributable to stretching energy of a C—H bond, it is preferable that the polymer (P) be substantially free of a hydrogen atom, and it is particularly preferable that every hydrogen atom bonded to a carbon atom be substituted by a fluorine atom in the polymer (P). Herein, saying that the polymer (P) is substantially free of a hydrogen atom means that the hydrogen atom content in the polymer (P) is 1 mol % or less.

The polymer (P) preferably has a fluorine-containing aliphatic ring structure. The fluorine-containing aliphatic ring structure may be included in a main chain of the polymer (P), or may be included in a side chain of the polymer (P). The polymer (P) has, for example, a structural unit (A) represented by the following formula (1).

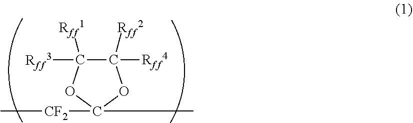

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² are optionally linked to form a ring. “Perfluoro” indicates that every hydrogen atom bonded to a carbon atom is substituted by a fluorine atom. In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (1), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

When R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) include structural units represented by the following formulae (A1) to (A8).

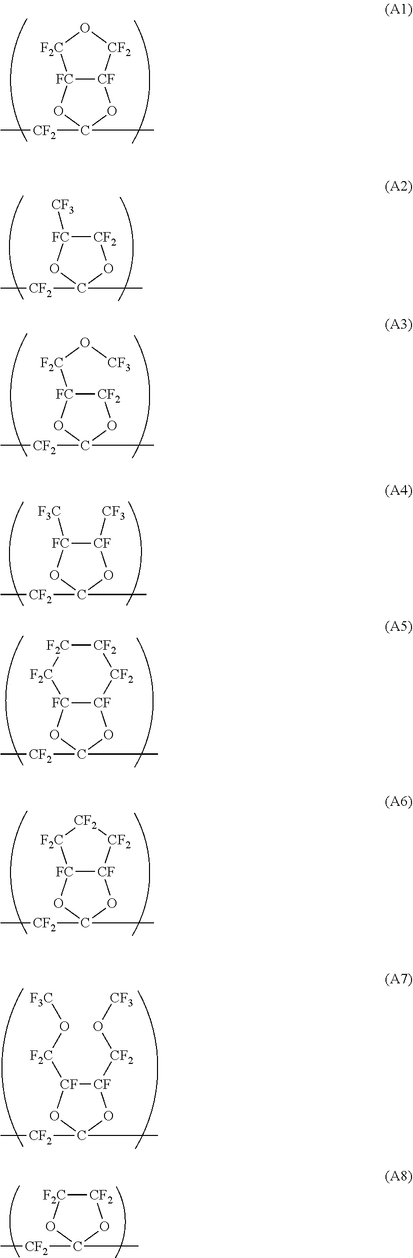

Among the structural units represented by the above formulae (A1) to (A8), the structural unit (A) is preferably the structural unit (A2), i.e., a structural unit represented by the following formula (2).

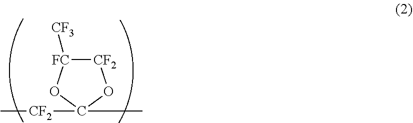

The polymer (P) may include one or more structural units (A). In the polymer (P), the content of the structural unit (A) is preferably 20 mol % or more and more preferably 40 mol % or more relative to a total content of all structural units. When including 20 mol % or more of the structural unit (A), the polymer (P) tends to have much higher thermal resistance. When including 40 mol % or more of the structural unit (A), the polymer (P) tends to have much higher transparency and much higher mechanical strength in addition to high thermal resistance. In the polymer (P), the content of the structural unit (A) is preferably 95 mol % or less and more preferably 70 mol % or less relative to the total content of all structural units.

The structural unit (A) is derived from, for example, a compound represented by the following formula (3). In the formula (3), R_{ff}¹ to R_{ff}⁴ are as described for the formula (1). It should be noted that the compound represented by the formula (3) can be obtained, for example, by an already-known manufacturing method such as a manufacturing method disclosed in JP 2007-504125 A.

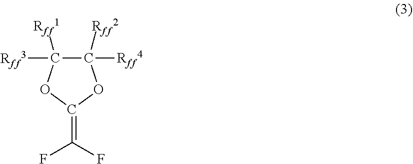

Specific examples of the compound represented by the above formula (3) include compounds represented by the following formulae (M1) to (M8).

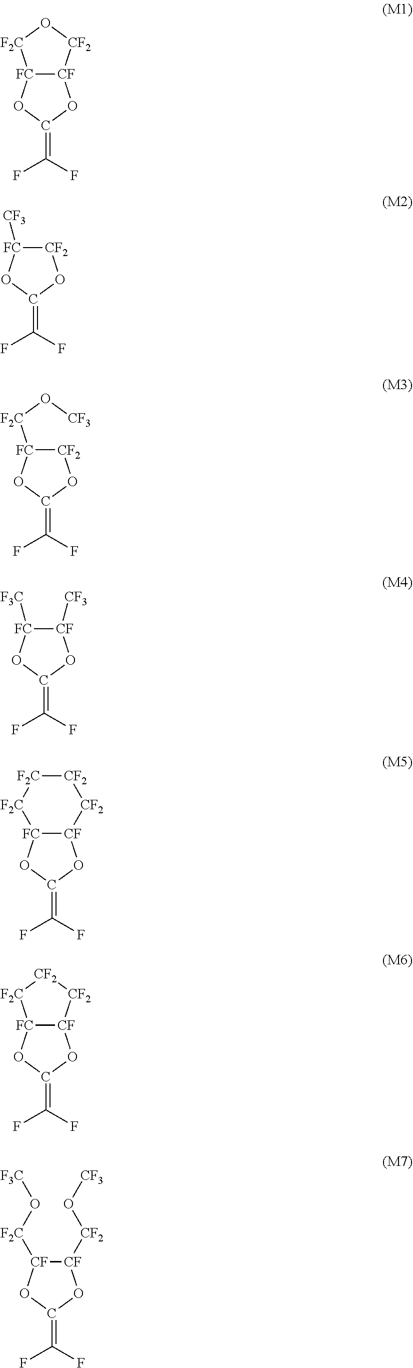

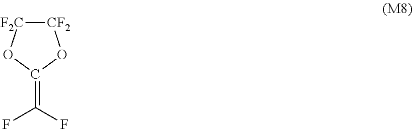 [SMILES: FC(F)=C1OC(F)(F)C(F)(F)O1]

The polymer (P) may further include an additional structural unit other than the structural unit (A). Examples of the additional structural unit include the following structural units (B) to (D).

The structural unit (B) is represented by the following formula (4).

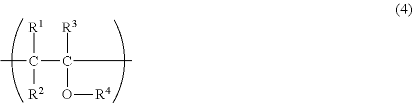

In the formula (4), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The polymer (P) may include one or more structural units (B). In the polymer (P), the content of the structural unit (B) is preferably 5 to 10 mol % relative to the total content of all structural units. The content of the structural unit (B) may be 9 mol % or less or 8 mol % or less.

The structural unit (B) is derived from, for example, a compound represented by the following formula (5). In the formula (5), R¹ to R⁴ are as described for the formula (4). The compound represented by the formula (5) is a fluorine-containing vinyl ether such as perfluorovinyl ether.

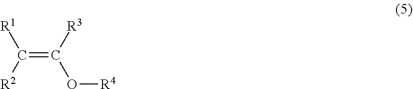

The structural unit (C) is represented by the following formula (6).

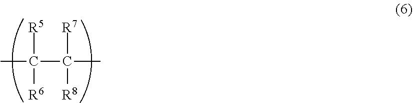

In the formula (6), R⁵ to R⁸ each independently represent a fluorine atom or a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The polymer (P) may include one or more structural units (C). In the polymer (P), the content of the structural unit (C) is preferably 5 to 10 mol % relative to the total content of all structural units. The content of the structural unit (C) may be 9 mol% or less or 8 mol % or less.

The structural unit (C) is derived from, for example, a compound represented by the following formula (7). In the formula (7), R⁵ to R⁸ are as described for the formula (6). The compound represented by the formula (7) is a fluorine-containing olefin such as tetrafluoroethylene or chlorotrifluoroethylene.

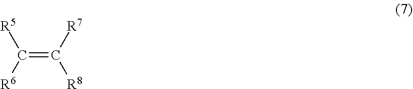

The structural unit (D) is represented by the following formula (8).

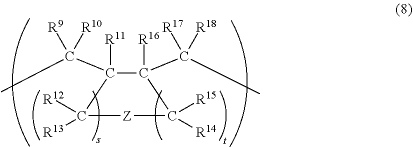

In the formula (8), Z represents an oxygen atom, a single bond, or —OC(R¹⁹R²⁰)O—, and R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom. Symbols s and t are each independently 0 to 5, and s+t is an integer of 1 to 6 (when Z is —OC(R¹⁹R²⁰)O—, s+t may be 0).

The structural unit (D) is preferably represented by the following formula (9). The structural unit represented by the following formula (9) is a structural unit represented by the above formula (8), where Z is an oxygen atom, s is 0, and t is 2.

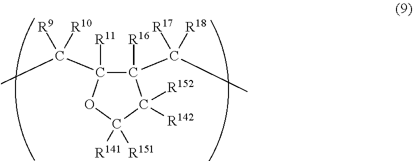

In the formula (9), R¹⁴¹, R¹⁴², R¹⁵¹, and R¹⁵² are each independently a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom.

The polymer (P) may include one or more structural units (D). In the polymer (P), the content of the structural unit (D) is preferably 30 to 67 mol % relative to the total content of all structural units. The content of the structural unit (D) is, for example, 35 mol % or more, and may be 60 mol % or less or 55 mol% or less.

The structural unit (D) is, for example, derived from a compound represented by the following formula (10). In the formula (10), Z, R⁹ to R¹⁸, s, and t are as described for the formula (8). The compound represented by the formula (10) is a cyclopolymerizable fluorine-containing compound having two or more polymerizable double bonds.

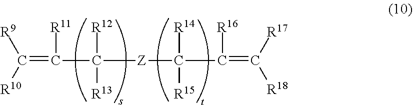

The structural unit (D) is preferably derived from a compound represented by the following formula (11). In the formula (11), R¹⁴¹, R¹⁴², R¹⁵¹, and R¹⁵² are as described for the formula (9).

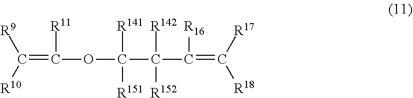

Specific examples of the compound represented by the formula (10) or the formula (11) include the following compounds.
CF₂═CFOCF₂CF═CF₂
CF₂═CFOCF(CF₃)CF═CF₂
CF₂═CFOCF₂CF₂CF═CF₂
CF₂═CFOCF₂CF(CF₃)CF═CF₂
CF₂═CFOCF(CF₃)CF₂CF═CF₂
CF₂═CFOCFClCF₂CF═CF₂
CF₂═CFOCCl₂CF₂CF═CF₂
CF₂═CFOCF₂OCF═CF₂
CF₂═CFOC(CF₃)₂OCF═CF₂
CF₂═CFOCF₂CF(OCF₃)CF═CF₂
CF₂═CFCF₂CF═CF₂
CF₂═CFCF₂CF₂CF═CF₂
CF₂═CFCF₂OCF₂CF═CF₂
CF₂═CFOCF₂CFClCF═CF₂
CF₂═CFOCF₂CF₂CCl═CF₂
CF₂═CFOCF₂CF₂CF═CFCl
CF₂═CFOCF₂CF(CF₃)CCl═CF₂
CF₂═CFOCF₂OCF═CF₂
CF₂═CFOCCl₂OCF═CF₂
CF₂═CClOCF₂OCCl═CF₂

The fluorine-containing copolymer of the present embodiment may further include an additional structural unit other than the structural units (A) to (D). However, the fluorine-containing copolymer of the present embodiment is preferably substantially free of an additional structural unit other than the structural units (A) to (D). That the polymer (P) is substantially free of an additional structural unit other than the structural units (A) to (D) means that a total content of the structural units (A) to (D) is 95 mol % or more and preferably 98 mol % or more relative to the total content of all structural units in the polymer (P).

The method for polymerizing the polymer (P) is not limited to a particular one, and a common polymerization method such as radical polymerization can be used. A polymerization initiator for the polymerization of the polymer (P) may be a fully-fluorinated compound.

A glass transition temperature (Tg) of the polymer (P) is, for example, but not particularly limited to, 100° C. to 140° C., and may be 105° C. or higher or 120° C. or higher. The term “Tg” herein refers to a midpoint glass transition temperature (T_{mg}) determined according to JIS K 7121: 1987.

The first resin material 1a may include the polymer (P) as a main component, and preferably consists essentially of the polymer (P). The first resin material 1a may further include an additive such as a refractive index modifier. The first resin material 1a is, for example, solid at ordinary temperature (25° C.).

The second resin material 1b preferably has composition suitable for the clad 3 of the POF 6. The refractive index of the second resin material 1b forming the clad 3 is preferably lower than the refractive index of the first resin material 1a forming the core 2. Examples of a resin material included in the second resin material 1b include fluorine-containing resins, acrylic resins such as methyl methacrylate, styrene resins, and carbonate resins.

Examples of the resin material included in the third resin material 1c forming the overclad 4 of the POF 6 include polyesters such as polyethylene terephthalate and polyethylene naphthalate, polyethersulfone, polycarbonate, various engineering plastics, cyclo-olefin polymer, polytetrafluoroethylene (PTFE), modified PTFE, and tetrafluoroethylene-perfluoroalkoxyethylene copolymer (PFA).

A first example of the resin fiber manufacturing method of the present embodiment is a method in which the resin fiber formation nozzle of the present embodiment such as the nozzle 20 is used. The method of the first example includes allowing a molten resin material to flow into the internal flow path of the resin fiber formation nozzle of the present embodiment such as the nozzle 20 through the inlet and to be discharged into a fiber shape through the outlet.

A second example of the resin fiber manufacturing method of the present embodiment is a method in which the resin fiber manufacturing apparatus of the present embodiment such as the above-described manufacturing apparatus 100 or 200 is used. The method of the second example includes:
extruding, from the extrusion apparatus of the resin fiber manufacturing apparatus of the present embodiment such as the manufacturing apparatus 100 or 200, a resin material being a raw material of a resin fiber; and
allowing the resin material extruded from the extrusion apparatus to flow into the internal flow path through the inlet of the nozzle and to be discharged into a fiber shape through the outlet.

A third example of the resin fiber manufacturing method of the present embodiment is a method in which the resin fiber manufacturing apparatus of the present embodiment such as the above-described POF manufacturing apparatus 200 is used. The method of the third example includes:
extruding the first resin material held in the first holding portion of the first extrusion apparatus of the resin fiber manufacturing apparatus of the present embodiment such as the POF manufacturing apparatus 200 from the first holding portion by the first extrusion portion to form the core;
forming a clad by extruding the second resin material held in the second holding portion of the second extrusion apparatus of the resin fiber manufacturing apparatus from the second holding portion by the second extrusion portion to cover the outer circumference of the core formed of the first resin material extruded from the first extrusion apparatus; and
allowing the layered body including the core and the clad and extruded from the second extrusion apparatus to flow into the internal flow path through the inlet of the nozzle and discharging the layered body through the outlet into a fiber shape.

A fourth example of the resin fiber manufacturing method of the present embodiment is any one of the methods of the above first to third examples further including cooling the resin material discharged into a fiber shape through the outlet of the nozzle by allowing the resin material to pass through a cooling pipe.

The resin fiber manufacturing method of the present embodiment can reduce variations of the outer diameter of a resin fiber manufactured thereby.

### EXAMPLES

Hereinafter, the present invention will be described in more detail with reference to Examples and Comparative Examples. The present invention is however not limited by these.

### Example 1

In Example 1, the POF manufacturing apparatus 200 shown in FIG. 4 was used to manufacture a POF. The nozzle 20 shown in FIG. 2 was used as the resin fiber formation nozzle. That is, a nozzle including an internal flow path having a tapered shape from an inlet toward an outlet was used as the resin fiber formation nozzle. Regarding the nozzle of Example 1, the taper angle θ₂ (θ₁) was 84.6°, the diameter D_{A2} of the inlet was 12.5 mm, the diameter D_{B2} of the outlet was 3 mm, the distance C₂ from the inlet to the outlet was 50 mm, tan θ₂ (tan θ₁) was 10.53. The nozzle of Example 1 was formed of a Hastelloy.

A fully-fluorinated amorphous resin was used as the first resin material for core formation. A fully-fluorinated amorphous resin was used as the second resin material for clad formation. Polycarbonate was used as the third resin material for overclad formation.

A layered body in which a core, a clad, and an overclad were concentrically layered was produced by multilayer melt extrusion using the first resin material, the second resin material, and the third resin material by means of the manufacturing apparatus 200. The layered body was allowed to flow into the internal flow path of the nozzle through the inlet of the nozzle. The layered body discharged in a fiber shape through the outlet of the nozzle was allowed to flow into the cooling pipe and cooled. The resulting fiber was wound around a winding roll to obtain a POF. The heating temperature and the flow rate of each resin material at the time of the melt extrusion were as follows.
First resin material (core): temperature 250° C., flow rate 3.6×10⁻⁹ m³/s
Second resin material (clad): temperature 260° C., flow rate 3.5×10⁻⁹ m³/s
Third resin material (overclad): temperature 250° C., flow rate 9.0×10⁻⁸ m³/s

In the obtained POF, the core had a diameter of 50 μm, the clad had an outer diameter of 70 μm, and the overclad had an outer diameter of 260 μm.

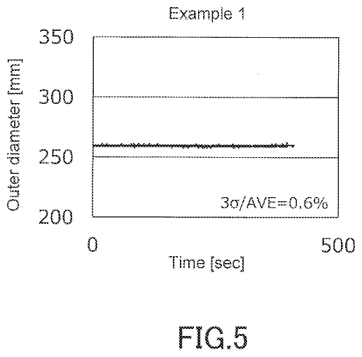

The fiber was measured for its outer diameters near the winding roll using a displacement meter (LS-9006M manufactured by Keyence Corporation). The obtained measured values were each defined as an outer diameter of the POF. The measurement cycle for the outer diameters was 0.1 seconds, and the number of measurement points was 4096. A graph of FIG. 5 shows the result for the outer diameter measurement. Moreover, the ratio 3σ/AVE was calculated from the obtained result. The ratio 3σ/AVE of the POF obtained in Example 1 was 0.6%.

### Comparative Example 1

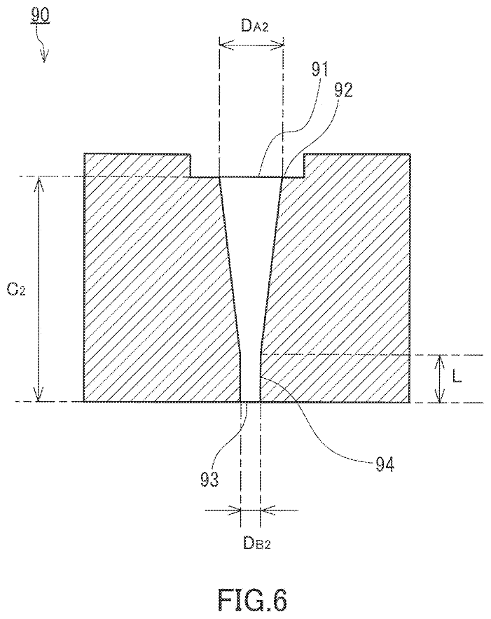

In Comparative Example 1, a nozzle 90 as shown in FIG. 6 was used as a resin fiber formation nozzle. The nozzle 90 includes an internal flow path 91, an inlet 92 that allows a resin material to flow into the internal flow path 91, an outlet 93 that allows the resin material to be discharged into a fiber shape from the internal flow path 91 to an outside of the nozzle 90. The internal flow path 91 was provided with, near the outlet 93, a land 94 extending linearly in a discharging direction. A section which is part of the internal flow path 91 and from which the land 94 is excluded had a tapered shape throughout the entire section, as in the nozzle used in Example 1. Regarding the nozzle of Comparative Example 1, the diameter D_{A2} of the inlet was 12.5 mm, the diameter D_{B2} of the outlet was 3 mm, the distance C₂ from the inlet to the outlet (i.e., from the inlet to the tip of the land) was 60 mm, and a land length L was 10 mm. The taper angle of a portion in a tapered shape was 84.6°, as in the nozzle of Example 1. The nozzle of Comparative Example 1 was formed of the same material as that of the nozzle of Example 1.

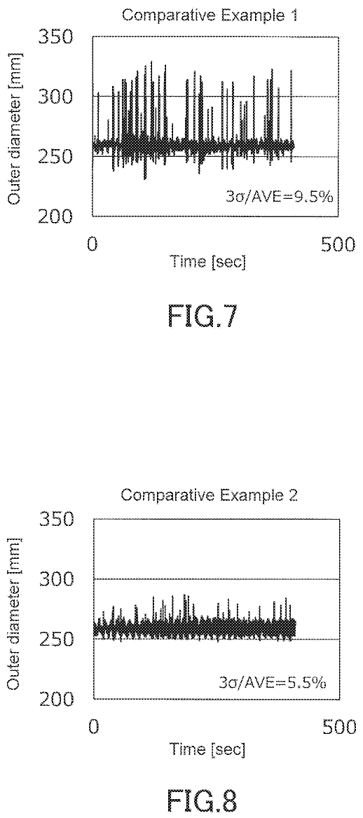

A POF was produced in the same manner as in Example 1, except that the nozzle 90 of Comparative Example 1 was used. The POF was measured for its outer diameters. A graph of FIG. 7 shows the result for the outer diameter measurement. Additionally, the ratio 3σ/AVE of the POF obtained in Comparative Example 1 was 9.5%.

### Comparative Example 2

The nozzle 90 having the same shape as that of the nozzle used in Comparative Example 1 but having a different land length L and a different distance C₂ was used in Comparative Example 2. Regarding the nozzle 90 of Comparative Example 2, the distance C₂ from the inlet to the outlet (i.e., from the inlet to the tip of the land) was 53 mm, and the land length L was 3 mm.

A POF was produced in the same manner as in Example 1, except that the nozzle 90 of Comparative Example 2 was used. The POF was measured for its outer diameters. A graph of FIG. 8 shows the result for the outer diameter measurement. Additionally, the ratio 3σ/AVE of the POF obtained in Comparative Example 2 was 5.5%.

### Comparative Example 3

In Comparative Example 3 was used an apparatus which was a POF manufacturing apparatus as used in Example 1 and Comparative Examples 1 and 2 and which had no cooling pipe. That is, in Comparative Example 3, the fiber-shaped layered body discharged through the outlet of the nozzle was cooled without flowing into a cooling pipe, and the resulting fiber was wound around the winding roll to obtain a POF. In Comparative Example 3, the POF was produced in the same manner as in Comparative Example 2, except that the apparatus used was not provided with a cooling pipe. That is, the nozzle used was the same as the nozzle 90 used in Comparative Example 2, the distance C₂ from the inlet to the outlet (i.e., from the inlet to the tip of the land) was 53 mm, and the land length L of the nozzle 90 was 3 mm.

The POF was measured for its outer diameters in the same manner as in Example 1. The ratio 3σ/AVE of the POF obtained in Comparative Example 3 was about 12%.

Comparison of the result of Example 1 and those of Comparative Examples 1 to 3 has revealed that variations of the outer diameter of the resulting POF can be reduced more using the nozzle of the present invention whose internal flow path has a reduced diameter in the section from the vicinity of the outlet to the outlet in the internal flow path than using the conventional nozzles whose internal flow path has a diameter not reduced in the section from the vicinity of the outlet to the outlet.

### Examples 2 to 8

The nozzle 20 as shown in FIG. 2 was used in Examples 2 to 8. Table 1 shows the diameter D_{A2} of the inlet, the diameter D_{B2} of the outlet, the distance C₂ from the inlet to the outlet, tan θ₂ (tan θ₁), and the taper angle θ₂ (9974 ₁) of the nozzle used in each Example. The nozzles of Examples 2 to 8 were also formed of the same material as that of the nozzle of Example 1. POFs were produced in the same manner as in Example 1, except that the nozzles of Examples 2 to 8 were used.

TABLE 1

| | D_{A2} | D_{B2} | C₂ | | θ₂ |
|---|---|---|---|---|---|
| | [mm] | [mm] | [mm] | tanθ₂ | [deg.] |
| Example 2 | 25 | 1 | 15 | 1.25 | 51.3 |
| Example 3 | 25 | 1 | 25 | 2.08 | 64.4 |
| Example 4 | 25 | 3 | 50 | 4.55 | 77.6 |
| Example 5 | 16 | 1.5 | 50 | 6.90 | 81.7 |
| Example 1 | 12.5 | 3 | 50 | 10.53 | 84.6 |
| Example 6 | 12.5 | 8 | 100 | 44.44 | 88.7 |
| Example 7 | 4 | 3 | 50 | 100.00 | 89.4 |
| Example 8 | 4 | 3 | 100 | 200.00 | 89.7 |

POFs for which variations of the outer diameter were reduced were produced using the nozzles of Examples 2 to 8, as in Example 1.

Comparison between the resin fibers of Examples 1 to 8 has revealed that by using the nozzles which have a tapered shape and have the inner flow path satisfying 4≤tan θ₂'100, variations of the outer diameter can be reduced and a resin fiber having a higher strength can be manufactured. The POFs of Examples 1 and 4 to 8 produced using the nozzles whose tan θ₂ is 4 or more are less breakable than the POFs of Examples 2 and 3 produced using the nozzles whose tan θ₂ is less than 4, and have sufficiently high strength. Compared to the POFs of Examples 1 to 7, variations of the outer diameter was slightly large for the POF of Example 8 produced using the nozzle whose tan θ₂ is more than 100. The reason may be that since the taper angle of the nozzle used in Example 8 is as large as 89.7 deg. and it is difficult to produce such a nozzle with high accuracy by machine processing, the taper angle became nearly 90 deg. by actual processing.

### INDUSTRIAL APPLICABILITY

The resin fiber formation nozzle and the resin fiber manufacturing apparatus of the present embodiment are suitable for POF manufacture.

1. A resin fiber formation nozzle configured to discharge a molten resin material into a fiber shape, comprising:
an internal flow path;
an inlet that allows the resin material to flow into the internal flow path; and
an outlet that allows the resin material to be discharged from the internal flow path to an outside of the nozzle, wherein
the internal flow path is shaped such that a diameter of the internal flow path decreases continuously, in a section from a position A 5 mm upstream in the internal flow path from the outlet to a position B of the outlet, from the position A toward the position B.

2. The nozzle according to claim 1, wherein the internal flow path has a tapered shape narrowing from the position A toward the position B.

3. The nozzle according to claim 2, wherein the internal flow path satisfies the following range (I) in the section from the position A to the position B:
4≤tan θ₁≤100 . . . (I),
where θ₁ represents a taper angle, and tan θ₁ is determined by the following equation (II):
tan θ₁=(a distance C₁ from the position A to the position B)/0.5(a diameter D_{A1} of the internal flow path at the position A−a diameter D_{B1} of the internal flow path at the position B) . . . (II).

4. The nozzle according to claim 1, wherein the internal flow path has a tapered shape narrowing from the inlet toward the outlet.

5. The nozzle according to claim 4, wherein the internal flow path satisfies the following range (III) in a section from the inlet to the outlet:
4≤tan θ₂≤100 . . . (III),
where θ₂ represents a taper angle, and tan θ₂ is determined by the following equation (IV):
tan θ₂=(a distance C₂ from the inlet to the outlet)/0.5(a diameter D₂ of the inlet−a diameter D_{B2} of the outlet) . . . (IV).

6. The nozzle according to claim 1, wherein the outlet has a diameter of 0.3 to 30 mm.

7. An apparatus for manufacturing a resin fiber, comprising:
an extrusion apparatus including: a holding portion that holds a resin material being a raw material of the resin fiber; and an extrusion portion that extrudes the resin material in a molten state from the holding portion; and
a nozzle that discharges, into a fiber shape, the resin material in a molten state extruded from the extrusion apparatus, wherein
the nozzle is the nozzle according to claim 1.

8. The resin fiber manufacturing apparatus according to claim 7, wherein the extrusion apparatus further includes a heating portion that heats and melts the resin material held in the holding portion.

9. The resin fiber manufacturing apparatus according to claim 7, wherein
the resin fiber is a plastic optical fiber including a core and a clad disposed on an outer circumference of the core,
the extrusion apparatus includes a first extrusion apparatus and a second extrusion apparatus,
the first extrusion apparatus includes: a first holding portion that holds a first resin material for forming the core; and a first extrusion portion that extrudes the first resin material in a molten state from the first holding portion to form the core,
the second extrusion apparatus includes: a second holding portion that holds a second resin material for forming the clad; and a second extrusion portion that extrudes the second resin material in a molten state to cover the outer circumference of the core formed of the first resin material extruded from the first extrusion apparatus, and
the nozzle is configured to discharge, into a fiber shape, a layered body including the core and the clad, the layered body being extruded from the second extrusion apparatus.

10. The resin fiber manufacturing apparatus according to claim 9, further comprising a dispersing tube provided between the extrusion apparatus and the nozzle, wherein
the dispersing tube is configured to disperse, in the layered body, a dopant included in the layered body passing inside the dispersing tube.

11. The resin fiber manufacturing apparatus according to claim 7, further comprising a cooling pipe including an internal space that allows the resin material discharged into a fiber shape from the nozzle to pass through the internal space.

12. The resin fiber manufacturing apparatus according to claim 11, wherein the cooling pipe is connected to the nozzle.

13. A resin fiber manufacturing method comprising allowing a molten resin material to flow into the internal flow path of the resin fiber formation nozzle according to claim 1 through the inlet and to be discharged into a fiber shape through the outlet.

14. A resin fiber manufacturing method comprising:
extruding, from the extrusion apparatus of the resin fiber manufacturing apparatus according to claim 7, a resin material being a raw material of the resin fiber; and
allowing the resin material extruded from the extrusion apparatus to flow into the internal flow path of the nozzle of the manufacturing apparatus through the inlet and to be discharged into a fiber shape through the outlet.

15. The resin fiber manufacturing method according to claim 14, wherein
the resin fiber is a plastic optical fiber including a core and a clad disposed on an outer circumference of the core,
the extrusion apparatus includes a first extrusion apparatus and a second extrusion apparatus,
the first extrusion apparatus includes: a first holding portion that holds a first resin material for forming the core; and a first extrusion portion that extrudes the first resin material in a molten state from the first holding portion to form the core,
the second extrusion apparatus includes: a second holding portion that holds a second resin material for forming the clad; and a second extrusion portion that extrudes the second resin material in a molten state to cover the outer circumference of the core formed of the first resin material extruded from the first extrusion apparatus,
the nozzle is configured to discharge, into a fiber shape, a layered body including the core and the clad, the layered body being extruded from the second extrusion apparatus, and
the resin fiber manufacturing method includes:
extruding the first resin material held in the first holding portion of the first extrusion apparatus of the manufacturing apparatus from the first holding portion by the first extrusion portion to form the core;
forming a clad by extruding the second resin material held in the second holding portion of the second extrusion apparatus of the manufacturing apparatus from the second holding portion by the second extrusion portion to cover the outer circumference of the core formed of the first resin material extruded from the first extrusion apparatus; and
allowing the layered body including the core and the clad and extruded from the second extrusion apparatus to flow into the internal flow path through the inlet of the nozzle and discharging the layered body through the outlet into a fiber shape.

16. The resin fiber manufacturing method according to claim 13, further comprising cooling the resin material discharged into a fiber shape through the outlet of the nozzle by allowing the resin material to pass through a cooling pipe.
